(19) United States
(12) Patent Application Publication
(10) Pub. No.: US 2026/0220972 A1
(43) Pub. Date: Jul. 30, 2026

(54) MODEL CONSTRUCTION METHOD, OBJECT RECOGNITION METHOD, ELECTRONIC DEVICE, AND MEDIUM

(71) Applicant: Beijing Zitiao Network Technology Co., Ltd., Haidian District, Beijing (CN)

(72) Inventor: Dengke DONG, Beijing (CN)

(21) Appl. No.: 19/144,656

(22) PCT Filed: Mar. 14, 2024
(86) PCT No.: PCT/CN2024/081599

§ 371 Date: Jun. 30, 2025

(30) Foreign Application Priority Data
Mar. 14, 2023 (CN) 202310267677.0

(51) Int. Cl. G06V 40/20; G06V 10/774; G06V 10/82; G06V 40/10

(52) U.S. Cl. CPC G06V 40/28; G06V 10/774; G06V 10/82; G06V 40/10; G06V 2201/07

(57) ABSTRACT

A model construction method, an object recognition method, an electronic device, and a medium including: obtaining a body recognition model, wherein the body recognition model comprises a body feature extraction network with known parameters, and the body recognition model is configured to identify a body; inputting training images into the body feature extraction network to obtain image body features; determining object recognition results of recognizing an object in the training images using an object recognition network based on the image body features, and updating the object recognition network based on the object recognition results, wherein the object recognized using the object recognition network is local part of the body; and constructing a target recognition model based on the body feature extraction network and the updated object recognition network, wherein the target recognition model is configured to perform recognition of the local part of the body in a target image.

### CROSS-REFERENCE TO RELATED APPLICATIONS

This application is based on and claims priority of the Chinese patent application No. 202310267677.0 filed on Mar. 14, 2023, entitled “MODEL CONSTRUCTION METHOD, OBJECT RECOGNITION METHOD, APPARATUS, DEVICE, MEDIUM, AND PRODUCT”, which is hereby incorporated into the present application by reference in its entirety.

### TECHNICAL FIELD

This disclosure relates to the technical field of image processing, in particular to a model construction method, an object recognition method, an apparatus, a device, a medium, and a product.

### BACKGROUND

Image-based gesture recognition refers to the recognition of a person's hand motion in an image, which can be used for gesture control and to improve interaction efficiency. Hand motion recognition requires first identifying a region in an image where a hand is located, also called a hand box, and then extracting a local image corresponding to the hand box and recognizing a gesture from the local image.

Related methods for identifying hand boxes in images mainly rely on model training of an image recognition network using a large number of training images comprising images and labels of the boxes in the images.

### SUMMARY

In a first aspect, an embodiment of the present disclosure provides a model construction method, comprising: obtaining a body recognition model, wherein the body recognition model comprises a body feature extraction network with known parameters, and the body recognition model is configured to identify a body; inputting training images into the body feature extraction network to obtain image body features; determining object recognition results of recognizing an object in the training images using an object recognition network based on the image body features, and updating the object recognition network based on the object recognition results, wherein the object recognized using the object recognition network is local part of the body; and constructing a target recognition model based on the body feature extraction network and the updated object recognition network, wherein the target recognition model is configured to perform recognition of the local part of the body in a target image.

In a second aspect, an embodiment of the present disclosure provides an object recognition method, comprising: receiving an image to be recognized in response to an image recognition request; obtaining a trained target recognition model, wherein the target recognition model comprises a body feature extraction network with known parameters and a trained object recognition network, and an object recognized by the object recognition network is local part of the body; extracting and obtaining image body features of the image to be recognized, based on the body feature extraction network with the known parameters; and determining an object recognition result corresponding to the image body features of the image to be recognized based on the trained object recognition network obtained, wherein the target recognition model is obtained using the model construction method described in the first aspect.

In a third aspect, an embodiment of the present disclosure provides a model construction apparatus, comprising: a first obtaining unit configured to obtain a body recognition model, wherein the body recognition model comprises a body feature extraction network with known parameters, and the body recognition model is configured to identify a body; a feature extraction unit configured to input training images into the body feature extraction network to obtain image body features; a model training unit configured to determine object recognition results of recognizing an object in the training images using an object recognition network based on the image body features, and update the object recognition network based on the object recognition results, wherein the object recognized using the object recognition network is local part of the body; and a model construction unit configured to construct a target recognition model based on the body feature extraction network and the updated object recognition network, wherein the target recognition model is configured to perform recognition of the local part of the body in a target image.

In a fourth aspect, an embodiment of the present disclosure provides an object recognition apparatus, comprising: an image receiving unit configured to receive an image to be recognized in response to an image recognition request; a second obtaining unit configured to obtain a trained target recognition model, wherein the target recognition model comprises a body feature extraction network with known parameters and an updated object recognition network; a feature extraction unit configured to extract and obtain image body features of the image to be recognized, based on the body feature extraction network with the known parameters; and an object recognition configured to determine an object recognition result corresponding to the image body features of the image to be recognized based on the trained object recognition network obtained, wherein the target recognition model is obtained using the model construction method described in the first aspect.

In a fifth aspect, an embodiment of the present disclosure provides an electronic device, comprising: a processor and a memory; wherein the memory is configured to store computer executable instructions; and the processor is configured to execute the computer executable instructions stored in the memory to cause the at least one processor to perform the model construction method described in the first aspect and various possible designs of the first aspect, or the object recognition method described in the second aspect and various possible designs of the second aspect.

In a sixth aspect, an embodiment of the present disclosure provides a computer readable storage medium storing thereon computer executable instructions that, when executed by a processor, implement the model construction method described in the first aspect and various possible designs of the first aspect, or the object recognition method described in the second aspect and various possible designs of the second aspect.

In a seventh aspect, an embodiment of the present disclosure provides a computer program product comprising a computer program that, when executed by a processor, implements the model construction method described in the first aspect and various possible designs of the first aspect, or the object recognition method described in the second aspect and various possible designs of the second aspect.

In an eighth aspect, according to one or more embodiments of the present disclosure, there is provided a computer program, comprising: instructions that, when executed by a processor, cause the processor to perform the model construction method or the object recognition method described in the aforementioned embodiments.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that the drawings illustrated as follows are merely some embodiments of the present disclosure. For a person skilled in the art, he or she may also acquire other drawings according to such drawings on the premise that no inventive effort is involved.

FIG. 1 is a diagram of an application network architecture of an object recognition method provided in an embodiment of the present disclosure;

FIG. 2 is a flowchart of a model construction method provided according to some embodiments of the present disclosure;

FIG. 3 is a flowchart of a model construction method provided according to other embodiments of the present disclosure;

FIG. 4 is a diagram of a target recognition model provided in an embodiment of the present disclosure;

FIG. 5 is a flowchart of an object recognition method provided according to some embodiments of the present disclosure;

FIG. 6 is a schematic structural diagram of an image processing apparatus provided in an embodiment of the present disclosure;

FIG. 7 is a schematic structural diagram of an object recognition apparatus provided in an embodiment of the present disclosure;

FIG. 8 is a schematic structural diagram of an electronic device provided in an embodiment of the present disclosure.

### DETAILED DESCRIPTION

In order to make objectives, technical schemes and advantages of the present disclosure more clear, a clear and complete description will be given for the technical solution of the embodiments of this disclosure with reference to the figures. Obviously, merely some embodiments of this disclosure, rather than all embodiments thereof, are given herein. All other embodiments obtained by persons of ordinary skill in the art based on the embodiments of the present disclosure without creative efforts shall fall within the protection scope of the present disclosure.

The technical solution of this disclosure can be applied to the scenarios of recognition of key parts, such as a hand box, a hand center in an image. By using a trained body recognition model, a body feature extraction network contained in the body recognition model can be utilized in a process of training a recognition network for an object, such as a hand box or a hand center. By reusing the body feature extraction network and updating the object recognition network, the construction of a target recognition model can be completed, thereby improving the efficiency of recognition model construction.

In related technologies, hand recognition is an important branch of artificial intelligence that can be applied to many fields, such as home appliances, transportation, finance, entertainment, etc. A common process flow for obtaining accurate hand recognition results may comprise recognizing a hand box, extracting a local image of the hand box, and then recognizing a hand pose in the local image. According to the above processing flow, it can be seen that the accuracy of hand box recognition is a critical factor in the accuracy of hand recognition. At present, hand box recognition models are generally obtained by training machine learning models or neural networks. Generally, a hand box recognition model can be trained using images and training data corresponding to hand box annotations in the images. This training process requires a large amount of training data, but only can achieve lower precision of the hand box recognition model that is trained based on the training data, resulting in low hand recognition accuracy.

At present, a large amount of training data is required to train a hand-box recognition network, and the problem of inaccurate hand box recognition is common in response to the label data being limited.

Therefore, how to accurately identify the hand box in the image is a critical technical problem that needs to be solved.

To solve the above technical problem, considering that a hand is essentially a component feature of a human body and that current body recognition models also need a training process, in the technical solution of this disclosure, a feature extraction network contained in a trained body recognition model is reused based on the trained body recognition model. After extracting features from an image based on the feature extraction network, regression networks for hands, hand centers, or other parts are added to achieve extraction of local part of the body. In this way, the feature extraction network contained in the body recognition model can be used to extract body features, and the body features learned by the body recognition model can be applied to the learning process of an object recognition network for a local portion, which can not only improve the extraction accuracy of the local part of the body, but also reduce the complexity of training the target recognition model.

In an embodiment of the present disclosure, the body recognition model can be obtained, which may comprise the body feature extraction network with known parameters. In addition, the body recognition model may also comprise a body recognition network with known parameters that can recognize an entire body based on the features extracted by the body feature extraction network. The body recognition model may be a trained model, and the feature extraction network can be reused based on the body recognition model. By inputting training images into the body feature extraction network, image body features can be obtained, which can be used for object recognition in the object recognition network. The object recognition network can then be updated based on the object recognition results obtained, allowing the body feature extraction network to be reused. The object recognized using the object recognition network can be local part of the body in an image to be recognized, such as a hand box, a hand center, etc. By fixing the body feature extraction network, corresponding features can be directly extracted using the body feature extraction network, and the extracted body features can be directly used for training the object recognition network, which can greatly reduce the difficulty of constructing the target recognition model. In addition, by using the body feature extraction network and the updated object recognition network, a target recognition model that can more accurately extract local part of the body can be constructed quickly and accurately. This technical solution can achieve the effect of improving both training efficiency and accuracy.

A detailed explanation of the technical solution of the present disclosure and how it solves the aforementioned technical problems will be given below with reference to specific embodiments. The following specific embodiments can be combined with each other, and the same or similar concepts or processes may not be repeated in some embodiments. Embodiments of the present invention will be described in detail below in combination with the drawings.

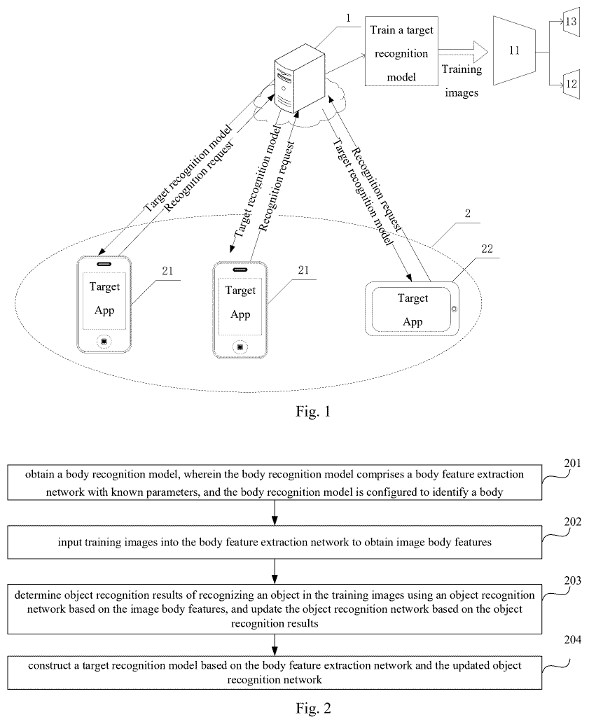

FIG. 1 is a diagram of an application network architecture of an object recognition method provided in an embodiment of the present disclosure. The application network architecture according to the embodiment of the present disclosure may comprise an electronic device and a client connected to the electronic device through a local area network or a wide area network. It is assumed that the electronic device may be a personal computer, a super personal computer, or a server such as a regular server, a cloud server, etc., and this disclosure is not limited to a specific type of electronic device. The client may be a terminal device, such as a mobile phone, tablet, personal computer, smart home appliance, or wearable device, and this disclosure is not limited to a specific type of client. As shown in FIG. 1, the electronic device is a cloud server 1 and the first client 2 comprises a mobile phone 21 and a tablet computer 22 as an example. A target recognition model can be trained based on the technical solution of the present disclosure in the cloud server 1. Any first client 2 can request the cloud server 1 to obtain the trained target recognition model. For example, the client can send a recognition request to the cloud server to obtain the trained target recognition model. Of course, in practical applications, the cloud server can also directly receive an image to be recognized and recognize a target object in the image to be recognized based on the object recognition method provided in this disclosure.

In response to the cloud server 1 using the technical solution of this disclosure to construct the object recognition model, the body feature extraction network 11 and the body recognition network 12 in the body recognition model can be fixed. An object recognition network 13 is added after the body feature extraction network 11, which may be, for example, one or more of a hand box recognition network and a hand center recognition network. During a training process of the object recognition network 13, the body feature extraction network 11 and the body recognition network 12 are fixed, i.e., the body feature extraction network 11 and the body recognition network 12 are not involved in the training process, and only the object recognition network 13 is trained.

Referring to FIG. 2, FIG. 2 is a flowchart of a model construction method provided according to some embodiments of the present disclosure. This model construction method may comprise the following steps 201 to 204.

In step 201, a body recognition model is obtained, wherein the body recognition model comprises a body feature extraction network with known parameters, and a body recognition network is configured to identify a body.

In some embodiments, the body recognition model can be configured to identify a body in an image. A body in an image can refer specifically to an entire body, comprising an entire body region and/or body key points. The entire body region can be a rectangular box containing an entire human body, and the body key points can be the positional points or coordinate points corresponding to different local parts of the body. Local parts of the body can comprise: hands, feet, upper and lower limbs, head, and other local part of the body.

The body recognition model can be trained in advance. The body recognition model may comprise the body feature extraction network with known parameters and the body recognition network with known parameters. The body feature extraction network can be configured to extract body features from input images. The body recognition network can be used to perform regression calculations on body features to obtain corresponding body boxes or the body key points. The specific information obtained using the body recognition network can be specified according to task requirements.

In some embodiments, the body recognition model can be constructed using network structures, such as convolutional neural networks, recurrent neural networks, etc. This embodiment is not limited to any specific algorithms used for the body recognition network.

In step 202, training images are inputted into the body feature extraction network to obtain image body features.

The body feature extraction network in step 202 is a trained body feature extraction network.

The training images may comprise two-dimensional training images and/or three-dimensional training images. The body feature extraction network can be directly used to extract body features from the training images. The image body features may be overall body features in the training images.

In step 203, object recognition results of recognizing an object in the training images using an object recognition network are determined based on the image body features, and the object recognition network is updated based on the object recognition results, wherein the object recognized using the object recognition network is local part of the body.

In some embodiments, the object recognition network can perform local part of the body recognition on input image body features to obtain object recognition results. The object recognition results are the results of recognizing a certain local part of bodies in the training images. The local part of the body may be, for example, part of the body such as a hand, a hand center, an eye and/or an eye center, etc. This embodiment is not limited to any particular local part of the body.

Updating the object recognition network based on the object recognition results may comprise determining recognition errors based on the object recognition results, determining whether the object recognition network meets a convergence condition based on the recognition errors, and determining the current object recognition network as an updated object recognition network in response to determining that the object recognition network meets the convergence condition, or updating the object recognition network based on the recognition errors in response to determining that the object recognition network does not meet the convergence condition. The method then returns to step 203 to continue execution.

In step 204, a target recognition model is constructed based on the body feature extraction network and the updated object recognition network, wherein the target recognition model is configured to perform recognition of the local part of the body in a target image.

In some embodiments, the target recognition model may comprise the body feature extraction network and the updated object recognition network. The body feature extraction network and the updated object recognition network can be configured to perform recognition of local part of the body, such as a hand, a hand center, etc.

In some embodiments, the target recognition model may be applied through the following steps: extracting features from an input image using the body feature extraction network, inputting the features output from the body feature extraction network into the updated object recognition network to recognize local part of the body based on the object recognition network, thereby achieving the cooperative application of the body feature extraction network and the object recognition network.

In some embodiments, the target recognition model may further comprise: a feature enhancement network between the body feature extraction network and the object recognition network, which enhances the output features of the body feature extraction network and inputs the enhanced features into the object recognition network for recognition of the local part of the body.

In an embodiment of the present disclosure, the body recognition model can be obtained, which may comprise the body feature extraction network with known parameters. In addition, the body recognition model may also comprise the body recognition network with known parameters that can be configured to recognize an entire body based on the features extracted by the body feature extraction network. The body recognition model may be a trained model, and the feature extraction network can be reused based on the body recognition model. By inputting training images into the body feature extraction network, image body features can be obtained, which can be used for object recognition in the object recognition network. The object recognition network can be updated with the object recognition results obtained, allowing the body feature extraction network to be reused. The object recognized using the object recognition network can be local part of the body in an image to be recognized, such as the hand box, the hand center, etc. By fixing the body feature extraction network, corresponding features can be directly extracted using the body feature extraction network, and the extracted body features can be directly used for training the object recognition network, which can greatly reduce the difficulty of constructing the target recognition model. In addition, by using the body feature extraction network and the updated object recognition network, the target recognition model can be constructed, and the target recognition model can more accurately extract local part of the body, the target recognition model can be constructed quickly and accurately. This technical solution can achieve the effect of improving both training efficiency and accuracy.

In addition, since the parameters of the body feature extraction network contained in the target recognition model are known, no additional feature network training is required. On the basis of the body feature extraction network, the object recognition network can be trained separately, thereby reducing the complexity of network training. Therefore, a small number of training images with local body labels can be used for this simple network training. In the model construction method of the present disclosure, high-precision training of the object recognition network can be achieved with a small number of annotated samples, i.e., training images. Based on the accurate recognition of the object recognition network, a target recognition model with high accuracy in local part of the body recognition can be obtained, which can achieve better model training effects at a lower annotation cost.

FIG. 3 shows a flowchart of a model construction method provided in other embodiments of the present disclosure. Different from the previous embodiments, the object recognition results are determined for training images via the object recognition network based on image body features, which can comprise steps 301 to 302.

In step 301, candidate parameters are determined for the object recognition network, wherein the candidate parameters are parameter values of various network functions in the object recognition network.

In some embodiments, the candidate parameters may be parameter values of various network functions in the object recognition network. The object recognition network may comprise a plurality of network functions, such as activation functions, excitation functions, etc. In some embodiments, each network function has corresponding weight and offset, respectively. A network function can generally be expressed as y=ω*f(x)+b, where f(x) is the network function, ω is a weight of the network function, and b is an offset or bias of the network function. The candidate parameters may comprise weight values and offset values.

The candidate parameters can be obtained through parameter initialization, for example, by randomly determining the parameter values corresponding to the network functions, or by obtaining historical parameters as the candidate parameters. In a training iteration, the candidate parameters of the object recognition network can remain unchanged. At the end of the training iteration, the candidate parameters of the object recognition network can be updated for iterative training of the network.

In step 302, the object recognition results corresponding to the image body features are determined based on the object recognition network corresponding to the candidate parameters.

The body feature extraction network can be an encoder in the target recognition model, and can accurately extract body features from images. In the process of constructing the object recognition model, the body feature extraction network is known, and the image body features can be extracted from training images using the body feature extraction network. The image body features may be vectors or matrices that represent body characteristics in the training images.

Specifically, step 302 may comprise: inputting the image body features into the object recognition network with corresponding candidate parameters, and obtaining the object recognition results. In addition, the image body feature can be enhanced, and the enhanced image body features can be input into the object recognition network with corresponding candidate parameters to obtain the object recognition results. Other processes can also be applied to the image body features before inputting them into the object recognition network corresponding to the candidate parameters.

Different from the previous embodiments, the object recognition network is updated based on the object recognition results in step 203, which may comprise steps 303 to 305.

In step 303, it is determined whether the object recognition network meets a convergence condition based on the object recognition results. In response to determining that the object recognition network meets the convergence condition, step 304 is executed, or in response to determining that the object recognition network does not meet the convergence condition, step 305 is executed.

In step 304, the candidate parameters are determined as target parameters, and the object recognition network corresponding to the target parameters is determined as an updated object recognition network.

In step 305, the candidate parameters are updated and the method returns to step 302 to continue execution.

The training images have associated recognition result labels, which can be the annotation results of local part of the body in the images. For example, in response to the local part recognized by the object recognition network being a hand, the recognition result label can be an annotation result characterized by a real rectangular box where the hand is located, referred to as the hand box label. In response to the local part recognized by the object recognition network being a hand center, the recognition result label can be the annotation result of a real coordinate point corresponding to the hand center.

determining whether the object recognition network meets the convergence condition based on the object recognition results may comprise: determining recognition errors based on the object recognition results and recognition result labels corresponding to the training images; determining whether the object recognition network meets the convergence condition based on the recognition errors; in response to determining that the object recognition network meets the convergence condition based on the recognition errors, determining that the current object recognition network is the updated object recognition network; and in response to determining that the object recognition network does not meet the convergence condition based on the recognition errors, updating the object recognition network based on the recognition errors.

The object recognition network can be configured to perform feature regression and classification on the image body features to obtain corresponding object recognition results. The object recognition result can comprise a rectangular box corresponding to a region where the object is located or a location point of the object. The type of result of the object recognition result can be determined based on the characteristics of the recognized object. For example, the object recognition result can be the hand box.

The object recognition results can be used for loss calculation of the object recognition network to obtain recognition errors. determining whether the object recognition network meets the convergence condition based on the recognition errors may comprise: determining whether the recognition errors are less than a loss threshold, determining that the recognition errors meet the convergence condition in response to determining that the recognition errors are less than the loss threshold; or determining that the recognition errors do not meet the convergence condition in response to determining that the recognition errors are greater than or equal to the loss threshold.

In some embodiments, updating the candidate parameters may comprise: updating the candidate parameters based on a gradient descent algorithm and the recognition errors to obtain updated candidate parameters.

In this embodiment, in response to training the object recognition network, the image body features are extracted from the training images using the body feature extraction network, and the local part of the body is recognized from the image body features to obtain object recognition results using the object recognition network corresponding to the candidate parameters. Convergence condition detection is performed for the object recognition network based on the object recognition results. The effectiveness of the current candidate parameters of the object recognition network can be evaluated base on the convergence condition, enabling the application of the object recognition network to the body feature extraction network during its training process, thereby reducing the complexity of network training, and improving the training efficiency of the object recognition network. In addition, the training process of the object recognition network is accurately monitored by determining whether the training process of the object recognition network can be terminated based on the convergence condition, thereby improving the training accuracy of the object recognition network.

In some embodiments, different from the previous embodiments, the object recognition network comprises a hand box recognition network. Determining the object recognition results of recognizing the object in the training images using the object recognition network based on the image body features may comprise: determining hand box recognition results corresponding to the image body features based on the hand box recognition network corresponding to hand box parameters, wherein the hand box parameters are candidate parameters of the hand box recognition network.

Updating the object recognition network based on the object recognition results comprises: determining whether the object recognition network meets a convergence condition based on the hand box recognition results; in response to determining that the object recognition network meets the convergence condition based on the hand box recognition results, determining the hand box recognition network corresponding to the hand box parameters as the updated object recognition network; in response to determining that the object recognition network does not meet the convergence condition based on the hand box recognition results, updating the hand box parameters, returning to and continuing the method of the determining the hand box recognition results corresponding to the image body features based on the hand box recognition network corresponding to the hand box parameters.

In some embodiments, determining hand box recognition results corresponding to the image body features based on the hand box recognition network corresponding to the hand box parameters, the hand box parameters being candidate parameters of the hand box recognition network may comprise: inputting the image body features into the hand box recognition network corresponding to the hand box parameters to obtain the hand box recognition results. The image body features can also be enhanced, and the enhanced image body features can be input into the hand box recognition network corresponding to the hand box parameters to obtain the hand box recognition results.

In some embodiments, the hand box recognition network can be configured to identify the hand box of the image body features. The hand box recognition result may comprise the rectangular box corresponding to the region where the hand is located in the image, which can be referred to as the hand box.

In some embodiments, in addition to the hand box recognition network, the object recognition network may also comprise recognition networks for other human body, such as a hand center recognition network, a face recognition network, etc., which can be determined according to the recognition purposes or requirements of the recognition networks.

In this embodiment, based on the image body features, the hand box recognition network corresponding to the hand box parameters can be configured for hand box recognition to obtain the hand box recognition results. Based on the hand box recognition results, it can be determined whether the object recognition network meets the convergence condition. In response to the fact that the object recognition network does not meet the convergence condition, the hand box parameters can be updated to achieve updating of the object recognition network. In response to the fact that the object recognition network meets the convergence condition, the hand box recognition network corresponding to the hand box parameters can be determined as the updated object recognition network. By determining whether the hand box recognition network corresponding to the hand box parameters meets the convergence condition based on the hand box recognition results, and then updating the parameters if the hand box recognition network does not meet the convergence condition, iterative updating of the hand box recognition network can be achieved to obtain an accurate hand box recognition network.

In some embodiments, the object recognition network may further comprise: a hand center recognition network and a hand box recognition network.

Determining the object recognition results of recognizing the object in the training images using the object recognition network based on the image body features comprises: determining hand box recognition results corresponding to the image body features based on the hand box recognition network corresponding to hand box parameters, wherein the hand box parameters are candidate parameters of the hand box recognition network; determining hand center recognition results corresponding to the image body features based on the hand center recognition network corresponding to hand center parameters, wherein the hand center parameters are candidate parameters of the hand center recognition network.

Updating the object recognition network based on the object recognition results comprises: determining whether the object recognition network meets a convergence condition based on the hand box recognition results and the hand center recognition results; in response to determining that the object recognition network meets the convergence condition based on the hand box recognition results and the hand center recognition results, determining the hand box recognition network corresponding to the hand box parameters and the hand center recognition network corresponding to the hand center parameters as the updated object recognition network; in response to determining that the object recognition network does not meet the convergence condition based on the hand box recognition results and the hand center recognition results, updating the hand box parameters and the hand center parameters, returning to and continuing the method of the determining the hand box recognition results corresponding to the image body features based on the hand box recognition network corresponding to the hand box parameters.

In some embodiments, the object recognition results may comprise hand box recognition results and hand center recognition results. The hand center recognition network can be configured to identify the center of a human hand, and the hand center recognition result can comprise hand center position coordinates, which may be coordinates of the hand center in the training image or the image to be recognized.

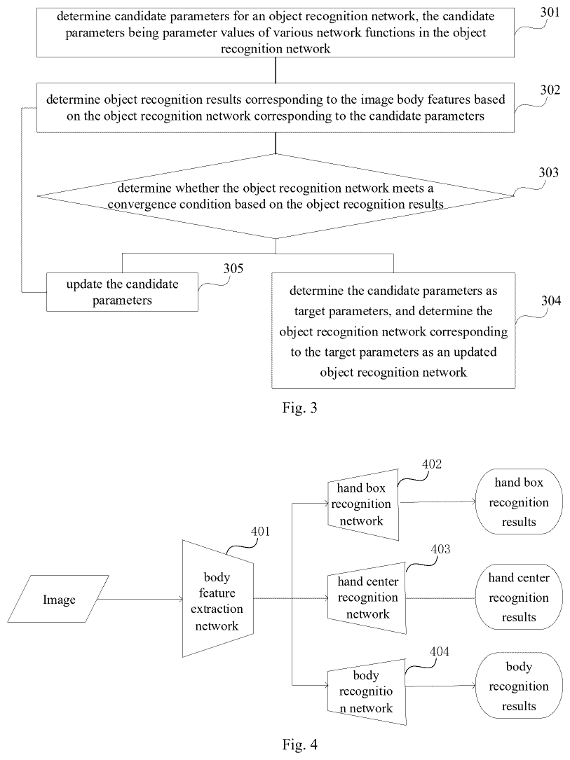

For ease of understanding, FIG. 4 shows a schematic diagram of a target recognition model provided in an embodiment of the present disclosure. Referring to FIG. 4, the target recognition model may comprise the body feature extraction network 401. The input of the body feature extraction network 401 may be an image, and its output may be connected to the hand box recognition network 402, the hand center recognition network 403, and the body recognition network 404, respectively. The features extracted by the body feature extraction network 401 may be input into the hand box recognition network 402, the hand center recognition network 403, and the body recognition network 404 respectively to obtain the hand box recognition result output by the hand box recognition network 402, the hand center recognition result output by the hand center recognition network 403, and the body recognition result output by the body recognition network 404. The body recognition result may comprise, for example, body key points or a body region.

In this embodiment, in addition to the hand box recognition network, the object recognition network may also comprise the hand center recognition network. By providing the hand center recognition network, effective utilization of the image body features can be further achieved. Furthermore, by adding the hand center recognition network on the basis of the hand box recognition network, co-training can be achieved with the two critical recognition objects of the hand, namely the hand box and the hand center, so that the training processes of the hand box recognition network and the hand center recognition network can influence each other to improve the recognition accuracy of the hand box recognition network and the hand center recognition network.

In some embodiments, determining whether the object recognition network meets the convergence condition based on the hand box recognition results and the hand center recognition results comprises: calculating a first loss value based on the hand box recognition results and hand box labels of the training images; calculating a second loss value based on the hand center recognition results and hand center labels of the training images; obtaining a target loss value by weighted summing of the first loss value and the second loss value; determining that the object recognition network meets the convergence condition, in response to determining that the target loss value satisfies a loss threshold; determining that the object recognition network does not meet the convergence condition, in response to determining that the target loss value does not satisfy the loss threshold.

In some embodiments, the first loss value can be obtained by calculating differences between the hand box recognition results and the hand box labels. For example, distances between the hand box recognition results and the hand box labels can be calculated to obtain the first loss value.

In some embodiments, the second loss value can be obtained by calculating differences between the hand center recognition results and the hand center labels. For example, distances between the hand center recognition results and the hand center labels can be calculated to obtain the second loss value.

The target loss value can be calculated by weighted summing of the first loss value and the second loss value. It is possible to determine a first weight of the hand box recognition network and a second weight of the hand center recognition network, calculate a first value by multiplying the first weight by the first loss value, calculate a second value by multiplying the second weight by the second loss value, and calculate the sum of the first value and the second value to obtain the target loss value.

In some embodiments, the first weight and the second weight may be predetermined constants. In other embodiments, to improve the accuracy of the model construction, the first weight and the second weight can be used as training parameters to participate in the training of the hand box recognition network and the hand center recognition network. In this case, the training results of the first weight and the second weight are the weight values obtained in the last iteration.

In some embodiments, the target loss value that satisfies the loss threshold means that the target loss value is less than or equal to the loss threshold. The target loss value that does not satisfy the loss threshold means that the target loss value is greater than the loss threshold.

In this embodiment, the training effectiveness of the hand box recognition network and the hand center recognition network can be evaluated separately by calculating the first loss value of the hand box recognition network and the second loss value of the hand center recognition network. In addition, the final target loss value is calculated by weighting and summing the first loss value and the second loss value to achieve a comprehensive loss calculation of the two loss values. This enables both networks, the hand box recognition network and the hand center recognition network, to jointly perform the determination of co-convergence condition, allowing simultaneous training of both networks. In addition, the hand center recognition network and the hand box recognition network influence each other to improve the accuracy of the network recognition.

In some embodiments, based on any of the above embodiments, the step of determining the recognition result labels corresponding to the training images using the object recognition network comprises: determining body key point labels of the training images in training the body recognition model; generating the recognition result labels corresponding to the training images using the object recognition network, based on the body key point labels.

In some embodiments, the recognition result labels may be determined based on the recognition object of the object recognition network. For example, in response to the recognition object of the object recognition network being the hand center, the recognition result label can be the hand center label. In response to the recognition object of the object recognition network being the hand box, the recognition result label can be a hand box label.

In some embodiments, the hand center labels of the training images using the object recognition network can be generated, based on the body key point labels. The hand box labels of the training images using the object recognition network can be generated, based on the body key point labels.

In an embodiment of the present disclosure, the body key point labels from the existing training images in training the body recognition model are obtained, and the recognition result labels corresponding to the training images in the object recognition network are generated, based on the body key point labels. For example, based on the positional constraint relationship between the body key points and the recognition object, the existing body key point labels can be used to annotate the recognition result labels corresponding to local part of the body through interpolation, fitting, etc. Especially in response to there being only a limited number of recognition result labels corresponding to the recognition object, reusing the body key point labels can improve annotation efficiency and increase the number of labels.

In some embodiments, after obtaining the target loss value by weighting and summing the first loss value and the second loss value, the method further comprises: updating the hand box parameters and the hand center parameters based on the target loss value.

In some embodiments, the hand box parameters and the hand center parameters can be updated using the target loss value combined with a gradient descent algorithm. Of course, other parameter update algorithms may be used, such as stochastic gradient descent, etc. The specific algorithm used for parameter updating is not limited in this embodiment.

In this embodiment, updating the hand center parameters and the hand box parameters based on the target loss value in each iteration can incorporate the loss generated in the iteration into the parameter updating process of the hand box recognition network and the hand center recognition network, resulting in more accurate hand center parameters and hand box parameters.

In some embodiments, calculating the first loss value based on the hand box recognition results and the hand box labels of the training images comprises: calculating the first loss value corresponding to the hand box recognition results and the hand box labels of the training images using a regression loss function; and calculating the second loss value based on the hand center recognition results and the hand center labels of the training images comprises: calculating the second loss value corresponding to the hand center recognition results and the hand center annotations of the training images using a Mean Square Error (MSE) loss function.

The regression loss function may comprise any of a Mean Absolute Error (MAE) loss function (also known as L1 loss function), Mean Squared Error (MSE) loss function (also known as L2 loss function), and a Smoothed Mean Absolute Error loss function (Huber smoothed L1 loss function). The type of function used as the regression loss function is not specifically limited in this embodiment.

The Mean Squared Error (MSE) loss function, also known as the L2 loss function, can calculate an error by taking the sum of the squared differences between the predicted values and the target values. For the specific calculation methods of the regression loss function and the MSE loss function, please refer to the relevant techniques, which will not be repeated here.

In this embodiment, the first loss value can be calculated using the regression loss function, the second loss value can be calculated using the MSE function, and different loss functions can be used to evaluate the errors for different networks to achieve targeted loss calculation for different networks, making the selected loss functions more suitable for the corresponding recognition networks and improving the accuracy of the loss calculation.

In some embodiments, based on any of the above embodiments, the hand box recognition network may comprise a global average pooling layer and a fully connected layer. The hand center recognition network can be constructed based on the heatmap algorithm.

The global average pooling layer can be constructed using a global average pooling algorithm, which calculates the average of the raw data input for each channel, obtains a corresponding average for each channel, and uses the corresponding average for each channel as the input for the fully connected layer. The global average pooling algorithm can reduce the complexity of the data structure adopted for each channel and improve network computing speed.

The fully connected layer can be constructed using a Fully Connected (FC) algorithm and can be used for hand box classification. Fast and accurate hand box classification can be achieved by means of the fully connected layer. The heatmap algorithm can be used to identify hand centers from input features. Through implementing the above algorithms, the recognition of corresponding objects can be achieved.

In order to obtain an accurate body recognition model, in this scheme, the body recognition model can be trained. The training of the body recognition model can comprise the following steps: training and obtaining the body recognition model based on two-dimensional body annotation data; or training and obtaining the body recognition model based on the two-dimensional and three-dimensional body annotation data.

The two-dimensional body annotation data can comprise the training images and two-dimensional annotation data of the training images.

The three-dimensional body annotation data can comprise the training images and three-dimensional annotation data of the training images.

Two-dimensional annotated data refers to data that is represented in a two-dimensional manner, such as two-dimensional coordinate points, two-dimensional rectangular boxes, and so on. Three-dimensional annotation data may comprise image depth data in addition to the above two-dimensional data. For example, depth data can be added to the two-dimensional coordinate points or to the two-dimensional rectangular boxes.

The body recognition model can perform body recognition on images and obtain the body recognition results. The body involved in this disclosure comprise, but are not limited to, key points on body, body regions, etc. Of course, in practical applications, in addition to human bodies, the body can also comprise cartoon characters, animals, and other objects to be recognized.

In this embodiment, the body recognition model can be trained based on the two-dimensional body annotation data, or the body recognition model can be trained based on the two-dimensional body annotation data and the three-dimensional body annotation data. By training the body recognition model based on the two-dimensional body annotation data or the three-dimensional body annotation data in combination with two-dimensional body annotation data, the body recognition model enables accurate body recognition from images, thereby improving the training efficiency and accuracy of the body recognition model.

As a complete implementation of the body recognition procedure, in some embodiments, the body recognition model further comprises: a body recognition network with known parameters, and wherein the constructing the target recognition model based on the body feature extraction network and the updated object recognition network comprises: determining the target recognition model based on the body feature extraction network, the body recognition network, and the updated object recognition network, wherein the target recognition model is configured to perform recognition of the body and the local part of the body in the target image.

In the process of constructing the target recognition model, the parameters of the body feature extraction network and the body recognition network contained in the target recognition model remain unchanged, that is, the parameters of the body feature extraction network and the body recognition network are not iteratively updated. In contrast, the parameters of the object recognition network are continuously updated during the training until a convergence condition is met.

In this embodiment, obtaining the body recognition model can comprise obtaining the body feature extraction network and the body recognition network. In constructing the target recognition model, the body recognition network can be used as one of the recognition branches of the target recognition model. The object recognition network can be added on the basis of the body recognition network, and recognition network branches can be added on the basis of the same body feature extraction network to achieve multi-task recognition with a shared body feature extraction network (backbone). There is no need to separately train the feature extraction network to recognize the body and the local part of the body, which can reduce the complexity of model training, shorten the time required for model training, and improve the efficiency and accuracy of model acquisition.

FIG. 5 shows a flowchart of an object recognition method provided in an embodiment of the present disclosure. The object recognition method may comprise the following steps 501 to 504.

In step 501, an image to be recognized is received in response to an image recognition request.

In step 502, a trained target recognition model is obtained, wherein the target recognition model comprises a body feature extraction network with known parameters and a trained object recognition network.

In step 503, image body features of the image to be recognized are extracted and obtained based on the body feature extraction network with known parameters.

In step 504, an object recognition result corresponding to the image body features of the image to be recognized is obtained based on the trained object recognition network, wherein the target recognition model is obtained using the model construction method according to any of the above embodiments.

The object recognition result comprises the body and the local part of the body recognition results.

In some embodiments, the object recognition network may comprise: the hand center recognition network and/or the hand box recognition network. The object recognition result corresponding to the image body features of the image to be recognized may comprise: the hand center recognition result obtained by recognition based on the image body features of the image to be recognized using the hand center recognition network, e.g., comprising the hand center coordinates, and/or the hand box recognition result obtained by recognition based on the image body features using the hand box recognition network, e.g., comprising the hand box.

In some embodiments, the object recognition network may further comprise: the body recognition network. The object recognition result corresponding to the image body features of the image to be recognized may further comprise: the body recognition result obtained by recognition based on the image body features of the image to be recognized using the body recognition network, e.g., comprising body key points or the rectangular box corresponding to the body region.

In the present embodiment, the image to be recognized can be received in response to the image recognition request. By obtaining the trained target recognition model, the body feature extraction network in the target recognition model can be configured to extract image body features of the image to be recognized. With the object recognition network, the object recognition result corresponding to the image body features of the image to be recognized can be obtained

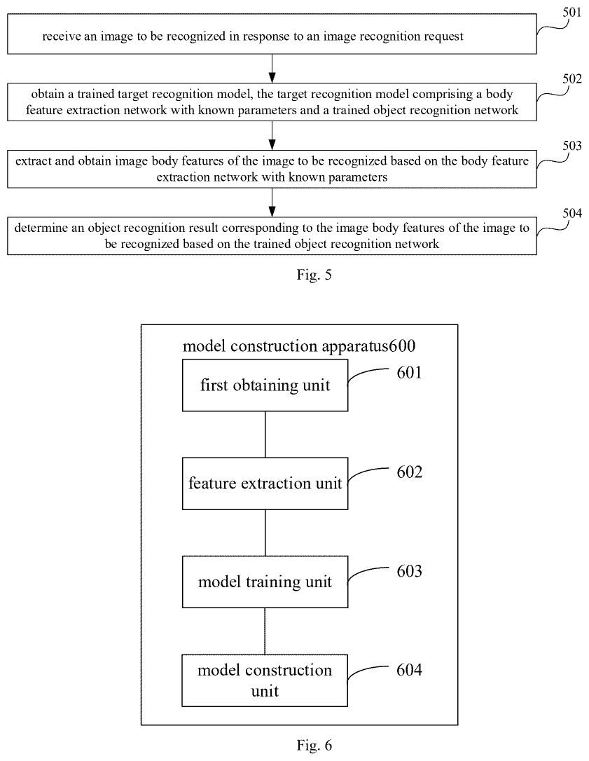

FIG. 6 is a schematic structural diagram of a model construction apparatus provided in an embodiment of the present disclosure. The model construction apparatus 600 may comprise a first obtaining unit 601, a feature extraction unit 602, a model training unit 603, and a model construction unit 604.

The first obtaining unit 601 is configured to obtain the body recognition model, wherein the body recognition model comprises the body feature extraction network with known parameters, and the body recognition model is configured to identify the body.

The feature extraction unit 602 is configured to input the training images into the body feature extraction network to obtain image body features.

The model training unit 603 is configured to determine the object recognition results of recognizing the object in the training images using the object recognition network based on the image body features, and update the object recognition network based on the object recognition results, wherein the object recognized using the object recognition network is the local part of the body.

The model construction unit 604 is configured to construct the target recognition model based on the body feature extraction network and the updated object recognition network, wherein the target recognition model is configured to perform recognition of the local part of the body in target images.

In some embodiments, the model training unit may comprise: a first determination module configured to determine candidate parameters for the object recognition network, wherein the candidate parameters are parameter values of various network functions in the object recognition network; a first recognition module configured to determine the object recognition results corresponding to the image body features based on the object recognition network corresponding to the candidate parameters; a first processing module configured to determine, in response to determining that the object recognition network meets the convergence condition based on the object recognition results, the candidate parameters as target parameters, and determining the body recognition network corresponding to the target parameters as the updated object recognition network; and a second processing module configured to update, in response to determining that the object recognition network does not meet the convergence condition based on the object recognition results, the candidate parameters, retuning to and continuing the method of the determining the body recognition results corresponding to the image body features based on the object recognition network corresponding to the candidate parameters.

In some embodiments, the object recognition network comprises the hand box recognition network, and the model training unit may further comprise: a second determination module configured to determine the hand box recognition results corresponding to the image body features based on the hand box recognition network corresponding to hand box parameters, wherein the hand box parameters are candidate parameters of the hand box recognition network; and a first determination module configured to determine whether the object recognition network meets the convergence condition based on the hand box recognition results; in response to determining that the object recognition network meets the convergence condition based on the hand box recognition results, determine the hand box recognition network corresponding to the hand box parameters as the updated object recognition network; in response to determining that the object recognition network does not meet the convergence condition based on the hand box recognition results, update the hand box parameters, return to and continue the method of the determining the hand box recognition results corresponding to the image body features based on the hand box recognition network corresponding to the hand box parameters.

In some embodiments, the object recognition network comprises: the hand center recognition network and the hand box recognition network. The model training unit may further comprise: a third determination module configured to determine the hand box recognition results corresponding to the image body features based on the hand box recognition network corresponding to the hand box parameters, wherein the hand box parameters are the candidate parameters of the hand box recognition network; a fourth determination module configured to determine the hand center recognition results corresponding to the image body features based on the hand center recognition network corresponding to the hand center parameters, wherein the hand center parameters are candidate parameters of the hand center recognition network; and a second determination module configured to determine whether the object recognition network meets the convergence condition based on the hand box recognition results and the hand center recognition results; in response to determining that the object recognition network meets the convergence condition based on the hand box recognition results and the hand center recognition results, determine the hand box recognition network corresponding to the hand box parameters and the hand center recognition network corresponding to the hand center parameters as the updated object recognition network; in response to determining that the object recognition network does not meet the convergence condition based on the hand box recognition results and the hand center recognition results, update the hand box parameters and the hand center parameters, return to and continue the method of the determining the hand box recognition results corresponding to the image body features based on the hand box recognition network corresponding to the hand box parameters.

In some embodiments, the second judgment module comprises: a first calculation submodule configured to calculate the first loss value based on the hand box recognition results and the hand box labels of the training images; a second calculation submodule configured to calculate the second loss value based on the hand center recognition results and the hand center labels of the training images; a target calculation submodule configured to obtain the target loss value by weighted summing of the first loss value and the second loss value; a first determination submodule configured to determine that the object recognition network meets the convergence condition, in response to determining that the target loss value satisfies the loss threshold; and a second determination submodule configured to determine that the object recognition network does not meet the convergence condition, in response to determining that the target loss value does not satisfy the loss threshold.

In some embodiments, the second determination module further comprises: a label determination unit configured to determine the body key point labels of the training images in training the body recognition model; and a label generation unit configured to generate the recognition result labels corresponding to the training images using the object recognition network based on the body key point labels.

In some embodiments, the second judgment module further comprises: a first training unit configured to train and obtain the body recognition model based on the two-dimensional body annotation data; or a second training unit configured to train and obtain the body recognition model based on the two-dimensional body annotation data and the three-dimensional body annotation data.

in some embodiments, the body recognition model further comprises: the body recognition network with known parameters, and the model construction unit is particularly configured to construct the target recognition model based on the body feature extraction network, the body recognition network, and an object recognition network to be trained.

In some embodiments, the model construction unit may be particularly configured to determine the target recognition model based on the body feature extraction network, the body recognition network, and the updated object recognition network, wherein the target recognition model is configured to perform recognition of the body and the local part of the body in the target image.

FIG. 7 is a schematic structural diagram of an object recognition apparatus provided in an embodiment of the present disclosure. The object recognition apparatus 700 may comprise an image receiving unit 701, a second obtaining unit 702, a feature extraction unit 703, and an object recognition unit 704.

The image receiving unit 701 is configured to receive the image to be recognized in response to the image recognition request.

The second obtaining unit 702 is configured to obtain the trained target recognition model, wherein the target recognition model comprises the body feature extraction network with known parameters and the updated object recognition network.

The feature extraction unit 703 is configured to extract and obtain the image body features of the image to be recognized based on the body feature extraction network with known parameters.

The object recognition unit 704 is configured to determine the object recognition result corresponding to the image body features of the image to be recognized based on the trained object recognition network, wherein the target recognition model is obtained using the model construction method according to any of the above embodiments.

The object recognition apparatus provided in this embodiment can perform the technical solution of the method embodiment described above. The implementation principle of the apparatus and the technical effect achieved are similar to those of the method embodiment, which will not be repeated here.

In order to implement the above embodiment, an embodiment of the present disclosure further provides an electronic device.

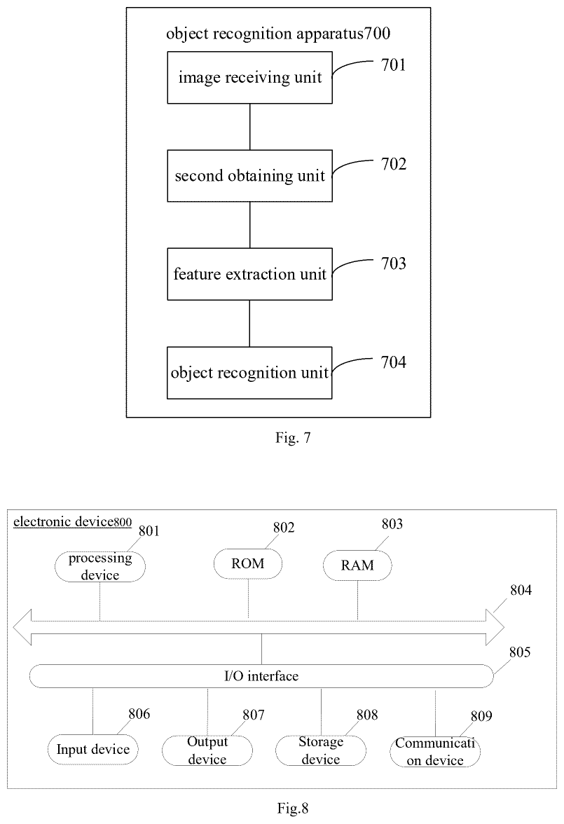

Referring now to FIG. 8, a schematic structural diagram of the electronic device 800 suitable for implementing the embodiments of the present disclosure is shown. The electronic device 800 may be a terminal device or a server. The terminal device may comprise, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), and a fixed terminal such as a digital TV, a desktop computer, and the like. The electronic device shown in FIG. 8 is merely an example and should not impose any limitation on the function and scope of the embodiments of the present disclosure.

As shown in FIG. 8, the electronic device 800 may comprise a processing device (e.g., a central processing unit, a graphics processor) 801, which may perform various appropriate actions and processes according to programs stored in Read Only Memory (ROM) 802 or programs loaded from storage device 808 into Random Access Memory (RAM) 803. In RAM 803, various programs and data required for the operation of the electronic device 800 are also stored. The processing device 801, ROM 802, and RAM 803 are connected to each other through a bus 804. An input/output (I/O) interface 805 is also connected to the bus 804.

Generally, the following devices can be connected to the I/O interface 805: input devices 806 comprising, for example, a touch screen, a touch pad, a keyboard, a mouse, a camera, a microphone, an accelerometer, a gyroscope, etc; output devices 807 comprising a liquid crystal display (LCD), a speaker, a vibrator, etc.; a storage device 808 such as a magnetic tape, a hard disk, etc; and a communication device 809. The communication device 809 enables the electronic device 800 to communicate in a wireless or wired manner with other devices to exchange data. Although FIG. 8 shows the electronic device 800 with various components, it should be understood that it is not required to implement or have all of these components. Alternatively, more or fewer means can be implemented or provided.

In particular, according to an embodiment of the present disclosure, the processes described above with reference to the flowchart can be implemented as a computer software program. For example, some embodiments of the present disclosure comprise a computer program product comprising a computer program carried on a computer-readable medium, the computer program containing program code for performing the method illustrated in the flowcharts. In such an embodiment, the computer program may be downloaded and installed from the network through the communication device 809, or installed from the storage device 808, or from the ROM 802. When the computer program is executed by the processing device 801, the above functions defined in the method of the embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, RF (radio frequency), etc., or any suitable combination of the foregoing.

The above computer readable medium may be comprised in the electronic device described above; or it may exist alone without being assembled into the electronic device.

The aforementioned computer-readable medium carries one or more programs that, when executed by an electronic device, cause the electronic device to perform the methods provided by the above embodiments.

The computer program code for performing the operations of the present disclosure may be written in one or more program design languages or a combination thereof, the program design languages comprising object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, comprising local area networks (LAN) or wide area networks (WAN), or connected to an external computer (for example, through an Internet connection provided by an Internet service provider).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. Wherein, the name of a unit does not constitute a limitation of the unit itself under certain circumstances, for example, a first obtaining unit may also be described as “a unit that obtains at least two Internet Protocol addresses”.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of thereof. More specific examples of the machine-readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

Embodiments of the present disclosure provide a model construction method, an object recognition method, an apparatus, a device, a medium, and a product to overcome the current difficulties in hand box training and low recognition accuracy.

In a first aspect, according to one or more embodiments of the present disclosure, there is provided a model construction method, comprising: obtaining a body recognition model, wherein the body recognition model comprises a body feature extraction network with known parameters, and the body recognition model is configured to identify a body; inputting training images into the body feature extraction network to obtain image body features; determining object recognition results of recognizing an object in the training images using an object recognition network based on the image body features, and updating the object recognition network based on the object recognition results, wherein the object recognized using the object recognition network is local part of the body; and constructing a target recognition model based on the body feature extraction network and the updated object recognition network, wherein the target recognition model is configured to perform recognition of the local part of the body in a target image.

According to one or more embodiments of the present disclosure, determining object recognition results of recognizing an object in the training images using an object recognition network based on the image body features comprises: wherein the determining the object recognition results of recognizing the object in the training images using the object recognition network based on the image body features comprises: determining candidate parameters for the object recognition network, wherein the candidate parameters are parameter values of various network functions in the object recognition network; and determining the object recognition results corresponding to the image body features based on the object recognition network corresponding to the candidate parameters; wherein the updating the object recognition network based on the object recognition results comprises: determining, in response to determining that the object recognition network meets a convergence condition based on the object recognition results, the candidate parameters as target parameters, and determining the body recognition network corresponding to the target parameters as the updated object recognition network; and updating, in response to determining that the object recognition network does not meet the convergence condition based on the object recognition results, the candidate parameters, and retuning to and continuing the method of the determining the object recognition results of recognizing the object in the training images using the object recognition network based on the image body features.

According to one or more embodiments of the present disclosure, the object recognition network comprises a hand box recognition network, and the determining the object recognition results of recognizing the object in the training images using the object recognition network based on the image body features comprises: determining hand box recognition results corresponding to the image body features based on the hand box recognition network corresponding to hand box parameters, wherein the hand box parameters are candidate parameters of the hand box recognition network; wherein the updating the object recognition network based on the object recognition results comprises: determining whether the object recognition network meets a convergence condition based on the hand box recognition results; determining, in response to determining that the object recognition network meets the convergence condition based on the hand box recognition results, the hand box recognition network corresponding to the hand box parameters as the updated object recognition network; and updating, in response to determining that the object recognition network does not meet the convergence condition based on the hand box recognition results, the hand box parameters, and returning to and continuing the method of the determining the hand box recognition results corresponding to the image body features based on the hand box recognition network corresponding to the hand box parameters.

According to one or more embodiments of the present disclosure, the object recognition network comprises: a hand center recognition network and a hand box recognition network, and the determining the object recognition results of recognizing the object in the training images using the object recognition network based on the image body features comprises: determining hand box recognition results corresponding to the image body features based on the hand box recognition network corresponding to hand box parameters, wherein the hand box parameters are candidate parameters of the hand box recognition network; and determining hand center recognition results corresponding to the image body features based on the hand center recognition network corresponding to hand center parameters, wherein the hand center parameters are candidate parameters of the hand center recognition network; wherein the updating the object recognition network based on the object recognition results comprises: determining whether the object recognition network meets a convergence condition based on the hand box recognition results and the hand center recognition results; determining, in response to determining that the object recognition network meets the convergence condition based on the hand box recognition results and the hand center recognition results, the hand box recognition network corresponding to the hand box parameters and the hand center recognition network corresponding to the hand center parameters as the updated object recognition network; and updating, in response to determining that the object recognition network does not meet the convergence condition based on the hand box recognition results and the hand center recognition results, the hand box parameters and the hand center parameters, returning to and continuing the method of the determining the hand box recognition results corresponding to the image body features based on the hand box recognition network corresponding to the hand box parameters.

According to one or more embodiments of the present disclosure, wherein the determining whether the object recognition network meets the convergence condition based on the hand box recognition results and the hand center recognition results comprises: calculating a first loss value based on the hand box recognition results and hand box labels of the training images; calculating a second loss value based on the hand center recognition results and hand center labels of the training images; obtaining a target loss value by weighted summing of the first loss value and the second loss value; determining that the object recognition network meets the convergence condition, in response to determining that the target loss value satisfies a loss threshold; and determining that the object recognition network does not meet the convergence condition, in response to determining that the target loss value does not satisfy the loss threshold.

According to one or more embodiments of the present disclosure, the step of determining the recognition result labels corresponding to the training images using the object recognition network comprises: determining body key point labels of the training images in training the body recognition model; and generating the recognition result labels corresponding to the training images using the object recognition network, based on the body key point labels.

According to one or more embodiments of the present disclosure, the step of training the body recognition model comprises: training and obtaining the body recognition model based on two-dimensional body annotation data; or training and obtaining the body recognition model based on the two-dimensional body annotation data and three-dimensional body annotation data.

According to one or more embodiments of the present disclosure, the body recognition model further comprises a body recognition network with known parameters, and the constructing the target recognition model based on the body feature extraction network and the updated object recognition network comprises: determining the target recognition model based on the body feature extraction network, the body recognition network, and the updated object recognition network, wherein the target recognition model is configured to perform recognition of the body and the local part of the body in the target image.

In a second aspect, according to one or more embodiments of the present disclosure, there is provided an object recognition method, comprising: receiving an image to be recognized in response to an image recognition request; obtaining a trained target recognition model, wherein the target recognition model comprises a body feature extraction network with known parameters and a trained object recognition network, and an object recognized by the object recognition network is local part of the body; extracting and obtaining image body features of the image to be recognized, based on the body feature extraction network with the known parameters; and determining an object recognition result corresponding to the image body features of the image to be recognized based on the trained object recognition network obtained, wherein the target recognition model is obtained using the model construction method according to any of the above embodiments.

In a third aspect, according to one or more embodiments of the present disclosure, there is provided a model construction apparatus, comprising: a first obtaining unit configured to obtain a body recognition model, wherein the body recognition model comprises a body feature extraction network with known parameters, and the body recognition model is configured to identify a body; a feature extraction unit configured to input training images into the body feature extraction network to obtain image body features; a model training unit configured to determine object recognition results of recognizing an object in the training images using an object recognition network based on the image body features, and update the object recognition network based on the object recognition results, wherein the object recognized using the object recognition network is local part of the body; and a model construction unit configured to construct a target recognition model based on the body feature extraction network and the updated object recognition network, wherein the target recognition model is configured to perform recognition of the local part of the body in a target image.

In a fourth aspect, according to one or more embodiments of the present disclosure, there is provided an object recognition apparatus, comprising: an image receiving unit configured to receive an image to be recognized in response to an image recognition request; a second obtaining unit configured to obtain a trained target recognition model, wherein the target recognition model comprises a body feature extraction network with known parameters and an updated object recognition network; a feature extraction unit configured to extract and obtain image body features of the image to be recognized, based on the body feature extraction network with the known parameters; and an object recognition configured to determine an object recognition result corresponding to the image body features of the image to be recognized based on the trained object recognition network obtained, wherein the target recognition model is obtained using the model construction method according to any of the above embodiments.

In a fifth aspect, according to one or more embodiments of the present disclosure, there is provided an electronic device, comprising: at least one processor and a memory; wherein the memory is configured to store computer executable instructions; the at least one processor is configured to execute the computer executable instructions stored in the memory to cause the at least one processor to perform the model construction method or the object recognition method provided in the foregoing embodiments.

In a fourth aspect, according to an embodiment of the present disclosure, there is provided a computer-readable storage medium storing computer executable instructions that, when executed by a processor, implement the model construction method or the object recognition method provided in the foregoing embodiments.

In a fifth aspect, according to one or more embodiments of the present disclosure, there is provided a computer program product comprising a computer program that, when executed by a processor, implements the model construction method or the object recognition method provided in the foregoing embodiments.

In a sixth aspect, according to one or more embodiments of the present disclosure, there is provided a computer program, comprising: instructions that, when executed by a processor, cause the processor to perform the model construction method or the object recognition method described in the foregoing embodiments.

In the technical solution of the embodiments of the present application, a body recognition model can be obtained, wherein the body recognition model comprises a body feature extraction network with known parameters, and the body recognition model is directly configured to extract the image body features of the training images. Object recognition can be performed on the image body features based on the object recognition network to obtain object recognition results of the training images, which can be configured to update the object recognition network, wherein an object recognized using the object recognition network can be local part of the body of the object body. By directly extracting corresponding features using the body feature extraction network, it is not necessary to train the feature extraction network, which can greatly reduce the difficulty of model construction. Moreover, the image body features learned by the body feature extraction network can be applied to the training of the object recognition network, which enables the object recognition network to learn the image body features and perform object recognition, wherein the object recognized by the object recognition network can be local part of the body. By reusing the body feature extraction parameters of the body recognition model, the object recognition network can be updated using the object recognition results, thereby reducing the number of networks to be updated and achieving fast and accurate training of the object recognition network. This technical solution can achieve the effect of improving both training efficiency and accuracy.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A model construction method, comprising:
obtaining a body recognition model, wherein the body recognition model comprises a body feature extraction network with known parameters, and the body recognition model is configured to identify a body;
inputting training images into the body feature extraction network to obtain image body features;
determining object recognition results of recognizing an object in the training images using an object recognition network based on the image body features, and updating the object recognition network based on the object recognition results, wherein the object recognized using the object recognition network is local part of the body; and
constructing a target recognition model based on the body feature extraction network and the updated object recognition network, wherein the target recognition model is configured to perform recognition of the local part of the body in a target image.

2. The model construction method according to claim 1,
wherein the determining the object recognition results of recognizing the object in the training images using the object recognition network based on the image body features comprises:
determining candidate parameters for the object recognition network, wherein the candidate parameters are parameter values of various network functions in the object recognition network; and
determining the object recognition results corresponding to the image body features based on the object recognition network corresponding to the candidate parameters;
wherein the updating the object recognition network based on the object recognition results comprises:
determining, in response to determining that the object recognition network meets a convergence condition based on the object recognition results, the candidate parameters as target parameters, and determining the body recognition network corresponding to the target parameters as the updated object recognition network; and
updating, in response to determining that the object recognition network does not meet the convergence condition based on the object recognition results, the candidate parameters, and retuning to and continuing the method of the determining the object recognition results of recognizing the object in the training images using the object recognition network based on the image body features.

3. The model construction method according to claim 1, wherein the object recognition network comprises a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network;
wherein the updating the object recognition network based on the object recognition results comprises:
determining whether the object recognition network meets a convergence condition based on the hand box recognition results;
determining, in response to determining that the object recognition network meets the convergence condition based on the hand box recognition results, the hand box recognition network corresponding to the hand box parameters as the updated object recognition network; and
updating, in response to determining that the object recognition network does not meet the convergence condition based on the hand box recognition results, the hand box parameters, and returning to and continuing the method of the determining the hand box recognition results corresponding to the image body features based on the hand box recognition network corresponding to the hand box parameters.

4. The model construction method according to claim 1, wherein the object recognition network comprises a hand center recognition network and a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network; and
determining hand center recognition results corresponding to the image body features based on the hand center recognition network corresponding to hand center parameters, wherein the hand center parameters are candidate parameters of the hand center recognition network;
wherein the updating the object recognition network based on the object recognition results comprises:
determining whether the object recognition network meets a convergence condition based on the hand box recognition results and the hand center recognition results;
determining, in response to determining that the object recognition network meets the convergence condition based on the hand box recognition results and the hand center recognition results, the hand box recognition network corresponding to the hand box parameters and the hand center recognition network corresponding to the hand center parameters as the updated object recognition network; and
updating, in response to determining that the object recognition network does not meet the convergence condition based on the hand box recognition results and the hand center recognition results, the hand box parameters and the hand center parameters, returning to and continuing the method of the determining the hand box recognition results corresponding to the image body features based on the hand box recognition network corresponding to the hand box parameters.

5. The model construction method according to claim 4, wherein the determining whether the object recognition network meets the convergence condition based on the hand box recognition results and the hand center recognition results comprises:
calculating a first loss value based on the hand box recognition results and hand box labels of the training images;
calculating a second loss value based on the hand center recognition results and hand center labels of the training images;
obtaining a target loss value by weighted summing of the first loss value and the second loss value;
determining that the object recognition network meets the convergence condition, in response to determining that the target loss value satisfies a loss threshold; and
determining that the object recognition network does not meet the convergence condition, in response to determining that the target loss value does not satisfy the loss threshold.

6. The model construction method according to claim 1, further comprising determining recognition result labels corresponding to the training images using the object recognition network, wherein the determining recognition result labels corresponding to the training images using the object recognition network comprises:
determining body key point labels of the training images in training the body recognition model; and
generating the recognition result labels corresponding to the training images using the object recognition network, based on the body key point labels.

7. The model construction method according to claim 1, wherein the obtaining the body recognition model comprises obtaining the body recognition model by training, and the obtaining the body recognition model by training comprises:
training and obtaining the body recognition model based on two-dimensional body annotation data; or
training and obtaining the body recognition model based on the two-dimensional body annotation data and three-dimensional body annotation data.

8. The model construction method according to claim 1, wherein the body recognition network further comprises a body recognition network with known parameters, and
the constructing the target recognition model based on the body feature extraction network and the updated object recognition network comprises:
determining the target recognition model based on the body feature extraction network, the body recognition network, and the updated object recognition network, wherein the target recognition model is configured to perform recognition of the body and the local part of the body in the target image.

9. The model construction method according to claim 1, wherein the target recognition model comprises a feature enhancement network, and wherein the feature enhancement network perform feature enhancement of the image body features outputted from the body feature extraction network.

10. An object recognition method, comprising:
receiving an image to be recognized in response to an image recognition request;
obtaining a trained target recognition model, wherein the target recognition model comprises a body feature extraction network with known parameters and a trained object recognition network, and an object recognized by the object recognition network is local part of the body;
extracting and obtaining image body features of the image to be recognized, based on the body feature extraction network with the known parameters; and
determining an object recognition result corresponding to the image body features of the image to be recognized based on the trained object recognition network obtained, wherein the target recognition model is obtained using the model construction method according to claim 1.

11-12. (canceled)

13. An electronic device, comprising: a processor and a memory;
wherein the memory is configured to store computer executable instructions; and
the processor is configured to execute the computer executable instructions stored in the memory to cause the processor to perform a model construction, comprising:
obtaining a body recognition model, wherein the body recognition model comprises a body feature extraction network with known parameters, and the body recognition model is configured to identify a body;
inputting training images into the body feature extraction network to obtain image body features;
determining object recognition results of recognizing an object in the training images using an object recognition network based on the image body features, and updating the object recognition network based on the object recognition results, wherein the object recognized using the object recognition network is local part of the body; and
constructing a target recognition model based on the body feature extraction network and the updated object recognition network, wherein the target recognition model is configured to perform recognition of the local part of the body in a target image.

14. A non-transitory computer-readable storage medium stored thereon computer executable instructions that, when executed by a processor, implement a model construction method, comprising:
obtaining a body recognition model, wherein the body recognition model comprises a body feature extraction network with known parameters, and the body recognition model is configured to identify a body;
inputting training images into the body feature extraction network to obtain image body features;
determining object recognition results of recognizing an object in the training images using an object recognition network based on the image body features, and updating the object recognition network based on the object recognition results, wherein the object recognized using the object recognition network is local part of the body; and
constructing a target recognition model based on the body feature extraction network and the updated object recognition network, wherein the target recognition model is configured to perform recognition of the local part of the body in a target image.

15-16. (canceled)

17. The electronic device according to claims 13, wherein the determining the object recognition results of recognizing the object in the training images using the object recognition network based on the body image features comprises:
wherein the determining the object recognition results of recognizing the object in the training images using the object recognition network based on the image body features comprises:
determining candidate parameters for the object recognition network, wherein the candidate parameters are parameter values of various network functions in the object recognition network; and
determining the object recognition results corresponding to the image body features based on the object recognition network corresponding to the candidate parameters;
wherein the updating the object recognition network based on the object recognition results comprises:
determining, in response to determining that the object recognition network meets a convergence condition based on the object recognition results, the candidate parameters as target parameters, and determining the body recognition network corresponding to the target parameters as the updated object recognition network; and
updating, in response to determining that the object recognition network does not meet the convergence condition based on the object recognition results, the candidate parameters, and retuning to and continuing the method of the determining the object recognition results of recognizing the object in the training images using the object recognition network based on the image body features.

18. The electronic device according to claims 13, wherein the object recognition network comprises a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network;
wherein the updating the object recognition network based on the object recognition results comprises:
determining whether the object recognition network meets a convergence condition based on the hand box recognition results;
determining, in response to determining that the object recognition network meets the convergence condition based on the hand box recognition results, the hand box recognition network corresponding to the hand box parameters as the updated object recognition network; and
updating, in response to determining that the object recognition network does not meet the convergence condition based on the hand box recognition results, the hand box parameters, and returning to and continuing the method of the determining the hand box recognition results corresponding to the image body features based on the hand box recognition network corresponding to the hand box parameters.

19. The electronic device according to claims 13, wherein the object recognition network comprises a hand center recognition network and a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network; and
determining hand center recognition results corresponding to the image body features based on the hand center recognition network corresponding to hand center parameters, wherein the hand center parameters are candidate parameters of the hand center recognition network;
wherein the updating the object recognition network based on the object recognition results comprises:
determining whether the object recognition network meets a convergence condition based on the hand box recognition results and the hand center recognition results;
determining, in response to determining that the object recognition network meets the convergence condition based on the hand box recognition results and the hand center recognition results, the hand box recognition network corresponding to the hand box parameters and the hand center recognition network corresponding to the hand center parameters as the updated object recognition network; and
updating, in response to determining that the object recognition network does not meet the convergence condition based on the hand box recognition results and the hand center recognition results, the hand box parameters and the hand center parameters, returning to and continuing the method of the determining the hand box recognition results corresponding to the image body features based on the hand box recognition network corresponding to the hand box parameters.

20. An electronic device, comprising: a processor and a memory;
wherein the memory is configured to store computer executable instructions; and
the processor is configured to execute the computer executable instructions stored in the memory to cause the processor to perform the object recognition method according to claim 10.

21. The non-transitory computer-readable storage medium according to claims 14,
wherein the determining the object recognition results of recognizing the object in the training images using the object recognition network based on the image body features comprises:
determining candidate parameters for the object recognition network, wherein the candidate parameters are parameter values of various network functions in the object recognition network; and
determining the object recognition results corresponding to the image body features based on the object recognition network corresponding to the candidate parameters;
wherein the updating the object recognition network based on the object recognition results comprises:
determining, in response to determining that the object recognition network meets a convergence condition based on the object recognition results, the candidate parameters as target parameters, and determining the body recognition network corresponding to the target parameters as the updated object recognition network; and
updating, in response to determining that the object recognition network does not meet the convergence condition based on the object recognition results, the candidate parameters, and retuning to and continuing the method of the determining the object recognition results of recognizing the object in the training images using the object recognition network based on the image body features.

22. The non-transitory computer-readable storage medium according to claims 14, wherein the object recognition network comprises a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network;
wherein the updating the object recognition network based on the object recognition results comprises:
determining whether the object recognition network meets a convergence condition based on the hand box recognition results;
determining, in response to determining that the object recognition network meets the convergence condition based on the hand box recognition results, the hand box recognition network corresponding to the hand box parameters as the updated object recognition network; and
updating, in response to determining that the object recognition network does not meet the convergence condition based on the hand box recognition results, the hand box parameters, and returning to and continuing the method of the determining the hand box recognition results corresponding to the image body features based on the hand box recognition network corresponding to the hand box parameters.

23. The non-transitory computer-readable storage medium according to claims 14, wherein the object recognition network comprises a hand center recognition network and a hand box recognition network, and
the determining the object recognition results of recognizing the object in the training images using the object recognition network based on the image body features comprises:
determining hand box recognition results corresponding to the image body features based on the hand box recognition network corresponding to hand box parameters, wherein the hand box parameters are candidate parameters of the hand box recognition network; and
determining hand center recognition results corresponding to the image body features based on the hand center recognition network corresponding to hand center parameters, wherein the hand center parameters are candidate parameters of the hand center recognition network;
wherein the updating the object recognition network based on the object recognition results comprises:
determining whether the object recognition network meets a convergence condition based on the hand box recognition results and the hand center recognition results;
determining, in response to determining that the object recognition network meets the convergence condition based on the hand box recognition results and the hand center recognition results, the hand box recognition network corresponding to the hand box parameters and the hand center recognition network corresponding to the hand center parameters as the updated object recognition network; and
updating, in response to determining that the object recognition network does not meet the convergence condition based on the hand box recognition results and the hand center recognition results, the hand box parameters and the hand center parameters, returning to and continuing the method of the determining the hand box recognition results corresponding to the image body features based on the hand box recognition network corresponding to the hand box parameters.

24. A non-transitory computer-readable storage medium stored thereon computer executable instructions that, when executed by a processor, implement the object recognition method according to claim 10.
